(19) United States
(12) Patent Application Publication
(10) Pub. No.: US 2024/0280204 A1
(43) Pub. Date: Aug. 22, 2024

(54) Light Train Centering Assembly and Method of Using

(71) Applicant: MORAY GROUP, LLC, ELK GROVE VILLAGE, IL (US)

(72) Inventors: CHRIS RAS, ELK GROVE VILLAGE, IL (US); ERIC BERGE, ELK GROVE VILLAGE, IL (US)

(73) Assignee: MORAY GROUP, LLC, ELK GROVE VILLAGE, IL (US)

(21) Appl. No.: 18/444,965

(22) Filed: Feb. 19, 2024

Related U.S. Application Data
(60) Provisional application No. 63/485,768, filed on Feb. 17, 2023.

(51) Int. Cl. F16L 55/165

(52) U.S. Cl. CPC F16L 55/1651

(57) ABSTRACT

An assembly and method is provided for repairing a pipeline. The assembly includes a liner, a bladder positioned within the liner, and a light train positioned within the bladder. One or more light train supports, which may be support members or support layers, are configured to move the light train toward the axial center of the bladder when the bladder is inflated.

This application is based upon U.S. Provisional Application Ser. No. 63/485,768 filed Feb. 17, 2023, the complete disclosure of which is hereby expressly incorporated by this reference.

### BACKGROUND

The present invention relates to a device and method for repairing pipe, such as underground sewer pipe and the like. Prior methods for repairing damaged pipelines include moving a liner tube impregnated with a liquid material capable of curing and hardening to a position within the pipe where the damaged portion is located. The liner tube is urged in an outward radial direction into contact with the pipeline being repaired and the liquid material impregnating the liner tube is permitted to cure and harden. The cured liner tube forms an interior liner in the pipe for the pipeline being repaired.

A method used for repairing pipelines includes the use of a liner tube having a felt layer on its inside and having a protective layer made of polymer or other plastic material on its outside. The liner tube is vacuum-impregnated with a resin mix in what is commonly referred to as a “wet-out” process. Just prior to wetting-out the liner, a catalyst is mixed with the resin so as to activate the resin and cause it to begin curing and hardening. The resin impregnated liner tube is then pulled, pushed, or inverted in the pipeline. In an inversion process the felt layer is inverted from the inside of the tube to the outside to help position the liner within the pipeline. Once the resin cures and hardens, the liner provides a new lining for the pipeline. Some resins are set to cure at ambient temperatures.

One problem with this method is that the catalyst must be mixed with the resin before the liner tube is wet-out and before positioning the liner tube at the damaged section of pipe. Once the catalyst is applied to the resin, the resin begins curing and time is of the essence in order to have the liner tube in place within the pipeline to be repaired. If the resin hardens before the liner tube is properly positioned within the pipe, it may require that a portion of the existing pipeline be dug up and replaced. If, on the other hand, a resin mix with a longer cure time is used to ensure adequate working time to install the liner, productivity suffers as the crew waits for the liner to cure and harden.

In recent years the industry has begun impregnating the liner with light-activated resin, then shining ultra violet (UV) light toward the liner to begin the curing process after the liner is positioned within the pipe system. The light may be provided by an elongated light train positioned within the liner/bladder assembly and having a plurality of lights configured to shine outwardly in all directions toward the resin impregnated liner. Light-activated resins help overcome certain drawbacks in other types of resins because the resin in the impregnated liner does not begin to cure until it is exposed to UV light. Once exposed, the resin impregnated liner cures quickly.

Existing light curing methods and assemblies have problems evenly curing the impregnated liner because the light train typically rests on the lower portion of the liner/bladder assembly. In other words, the light train is not centered within the lumen of the liner/bladder assembly. This causes different portions of the liner to be exposed to different amounts and intensities of light, which can cause the liner to have different cure properties. For example, the lower portion of the liner near the bottom of the pipe (which is closer to the light train) may be cured more than the upper portion of the liner near the top of the pipe. Further, when the liner is not centered within the lumen, more power is needed to cure the upper portion of the liner, which is more expensive and inefficient.

Therefore, there is a need for an improved method and apparatus for repairing pipes which overcomes these and other problems in the art.

### SUMMARY

According to one aspect of the present invention, a bladder assembly is provided for use with a repair assembly for repairing a pipeline. The bladder assembly includes a bladder made from a light-permeable material which allows one or more wavelengths of light to pass through. One or more light train supports, which may be support members in one embodiment, are secured to the bladder. The light train supports may be strips of a flexible material such as bladder material. The support members have attachment portions, which may be ends, secured to the bladder. Each support member may be a strip have two opposing ends, an “X” or cross shape having four ends, a star shape having six ends, or any other suitable shapes. In one embodiment the attachment portions of the support members are secured to the internal surface of the bladder at one or more locations along the length of the bladder. In some embodiments the attachment portions of the support members are attached on generally opposite sides of the internal surface of the bladder so that each support member extends generally across the internal diameter and through the axial center of the bladder when the bladder is inflated. In some embodiments, the attachment portions of each support member are spaced at different circumferential positions around the internal surface of the bladder. In some embodiments, the attachment portions of some support members are positioned about ninety degrees from the attachment portions of other support members to create an “X” or cross shape of support members when viewed longitudinally down the lumen of the inflated bladder. The support member may be pre-fabricated into the desired shape before being attached to the bladder. The support members are configured to support a lighting assembly having a light train. The light train is secured to the one or more support members at about the middle of each support member such that when the bladder is inflated, the support members support the light train near the axial center of the bladder. In some embodiments the support members have openings near their middle configured to receive the light train to support the light train near the axial center of the inflated bladder.

According to another aspect of the present invention, an assembly is provided for repairing a pipeline. The assembly is configured to be pushed or pulled into the pipeline. The assembly includes a liner configured to be impregnated with a resin having one or more light-activated initiators embodied therein. The assembly also includes a bladder positioned within the liner. The bladder is made from a light-permeable material which allows one or more wavelengths of light to pass through. One or more light train supports, which may be support members in one embodiment, are secured to the bladder. The support members may be strips of a flexible material such as bladder material which are secured to the bladder at one or more locations along the length of the bladder. The support members have attachment portions, which may be ends, secured to the bladder. In some embodiments the attachment portions of the support members are attached on generally opposite sides of the internal surface of the bladder so that each support member extends generally across the internal diameter and through the axial center of the bladder when the bladder is inflated. In some embodiments, the attachment portions of each support member are spaced at different circumferential positions around the internal surface of the bladder. In some embodiments, the attachment portions of some support members are positioned about ninety degrees from the attachment portions of other support members to create an “X” or cross shape of support members when viewed longitudinally down the lumen of the inflated bladder. A support member may be pre-fabricated into the desired shape having 4 ends, 6 ends, 8 ends, etc. . . . by combining multiple strips of support member material before attaching the multi-strip assembly to the bladder. The assembly further includes a lighting assembly having a light train positioned within the bladder. The light train is secured to the one or more support members at about the middle of each support member such that when the bladder is inflated, the support members support the light train near the axial center of the bladder. In some embodiments the support members have openings near their middle configured to receive the light train to support the light train near the axial center of the inflated bladder.

Another aspect of the present invention includes a method of making and using the assembly described in the preceding paragraph for repairing a pipeline. The method includes making the assembly described above by taking a bladder having a lumen therein, then inverting the bladder (turning the bladder inside out) so the bladder has an inverting face where the outside surface of the bladder becomes the inside surface of the bladder. Attaching the support members to the bladder within the lumen of the bladder behind the inverting face. Continuing to invert the bladder and attach support members to the bladder at predetermined distances along the length of the bladder until a plurality of support members are spaced within the lumen of the bladder. In some embodiments, attaching the support members to the inner surface of the bladder near the inverting face. In some embodiments the support members have attachment portions such as ends, and the method includes attaching the opposing attachment portions of the support members to the bladder at locations generally across the internal diameter of the bladder so the support members extend across the lumen and through the axial center of the bladder when the bladder is inflated. In some embodiments, attaching the attachment portions of support members at different circumferential positions around the internal surface of the bladder and different longitudinal positions so one or more support members are not parallel to each other when viewed longitudinally down the lumen of the inflated bladder. In some embodiments, attaching the attachment portions of some support members at about ninety degrees from the attachment portions of other support members to create an “X” or cross shape of support members within the lumen of the bladder. In some embodiments the support member is pre-fabricated into an “X” shape by combining two strips of support member material together before attaching the support member assembly to the bladder. A liner is then positioned around the bladder and a light train is secured to the support members. In some embodiments, the support members have openings near their center and the light train is positioned through the openings of the plurality of support members. The assembly may be positioned in the pipeline by pushing, pulling, or using a positioning device, such as a rope or robot. Fluid pressure (such as air pressure) is introduced to inflate the bladder and urge the liner into contact with the interior walls of the pipeline. Expansion of the bladder causes the support members to extend generally across the axial center of the lumen thereby moving the light train upward away from the floor of the bladder to a position near the axial center of the bladder along the length of the assembly. The light train is illuminated to cure the resin. After the liner cures and hardens the bladder is deflated and removed with the light train.

According to another aspect of the present invention, a bladder assembly is provided for use with a repair assembly for repairing a pipeline. The bladder assembly includes a bladder and a light train support, which may be a support layer in one embodiment. The bladder and support layer are made from an expandable light-permeable material which allows one or more wavelengths of light to pass through. The support layer may be made of the same material as the bladder. The support layer is secured to the bladder at one or more points or seams, which may extend axially along the length of the bladder. The bladder and support layer are inflated using fluid pressure after being positioned in the pipe to expand outward and urge the liner into contact with the inner wall of the pipe. An opening or valve is configured to allow fluid pressure to be introduced between the bladder and the support layer causing the inflated bladder to remain in place and the support layer to expand inwardly (away from the bladder) like one or more cushions toward the center of the lumen. The support layer is configured to support a light train near the axial center of the assembly as the support layer is inflated.

According to another aspect of the present invention, an assembly is provided for repairing a damaged portion of a pipeline. The assembly is configured to be positioned in the pipeline by any suitable means, including pulling, pushing, or inversion processes. The assembly includes a liner configured to be impregnated with a resin having one or more light-activated initiators embodied therein. The assembly also includes a bladder positioned within the liner and a light train support, which may be a support layer positioned within the bladder. The bladder and support layer are made from an expandable light-permeable material which allows one or more wavelengths of light to pass through. The support layer may be made of the same material as the bladder. The support layer is secured to the bladder at one or more points or seams, which may extend axially along the length of the bladder. The assembly further includes a lighting assembly having a light train positioned within the support layer. The bladder and support layer are inflated using fluid pressure after being positioned in the pipe to expand outward and urge the liner into contact with the inner wall of the pipe. The liner may be positioned in the pipe along with the bladder and support layer or the liner may be positioned in the pipe before the bladder and support layer are moved into place in the pipe. In embodiments where the assembly is inverted into the pipe, one end of the lateral light train is directly or indirectly combined with the closed/leading end of the bladder or support layer so that inversion of the bladder/support layer pulls the light train into the pipeline. An opening or valve is configured to allow fluid pressure to be introduced between the bladder and the support layer causing the inflated bladder to remain in place against the liner and the support layer to expand inwardly (away from the bladder) like one or more cushions toward the center of the lumen. As the support layer is inflated, the light train is supported by the support layers near the axial center of the assembly. The light train is illuminated to cure the resin. After the liner cures and hardens the bladder and support layer are deflated and removed with the light train.

Another aspect of the present invention includes a method of using the assembly described in the preceding paragraph for repairing a pipeline. The method includes making the assembly described above by positioning a support layer inside the bladder and securing the support layer to the inside of the bladder at a plurality of points or seams. In some embodiments the support layer is combined with the bladder along four longitudinal attachment axis spaced about 90 degrees from each other. This creates four inwardly expanding portions of the support layer between the four attachment axis. In use, the assembly is positioned in the pipe by any suitable means, including pushing, pulling, or inversion. The liner, bladder, and support layer may be positioned at the same time, or the liner may be positioned first, followed by the bladder and support layer. In inversion embodiments, one end of the lateral light train is directly or indirectly combined with the closed/leading end of the bladder or support layer so that inversion of the bladder/support layer pulls the light train into the pipeline. The bladder and support layer are inflated using fluid pressure after being positioned in the pipe to expand outward and urge the liner into contact with the inner wall of the pipe. Fluid pressure is then introduced into an opening or valve configured to allow fluid to be directed between the bladder and the support layer causing the inflated bladder to remain in place against the liner and the support layer to expand inwardly (except at points or seams where the support layer is combined with the bladder) like one or more cushions toward the center of the lumen. The inwardly expanding support layer lifts the light train and supports the light train near the center of the lumen. The light train is illuminated to cure the resin. After the liner cures and hardens the bladder and support layer are deflated and removed with the light train.

### BRIEF DESCRIPTION OF THE DRAWINGS

FIG. 1 is a section view showing a repair assembly being pulled into an underground pipe system.

FIG. 2 is section view showing the repair assembly positioned within the underground pipe system before inflation.

FIG. 3 is a top view of a support member.

FIG. 4 is a section view showing the repair assembly positioned within the underground pipe system after inflation.

FIG. 5 is a section view along the axis of the repair assembly after inflation.

FIG. 6 is a section view showing the repair assembly being inverted into an underground pipeline.

FIG. 7 is a section view showing the repair assembly positioned in the underground pipeline with the support layer inflated inwardly.

FIG. 8 is a section view along the axis of the repair assembly before the support layer is inflated inwardly.

FIG. 9 is a section view along the axis of the repair assembly after the support layer is inflated inwardly.

### DETAILED DESCRIPTION

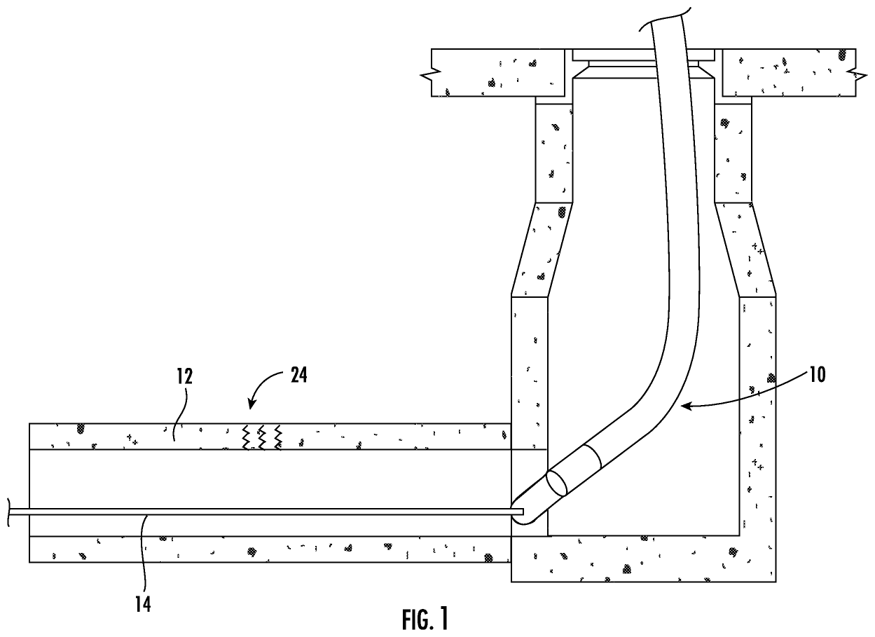

Assemblies and methods for repairing a pipeline 12 are provided. FIGS. 1-5 show a first embodiment wherein a bladder 16 assembly may be used with a repair assembly for repairing a pipeline 12 having a damaged portion 24 needing repair. The repair assembly is configured to be pushed or pulled into the pipeline 12 by any suitable means. In some embodiments the repair assembly is pulled into the pipeline 12 by attaching a positioning device 14, such as a rope or robot, to a portion of the assembly as shown in FIG. 1.

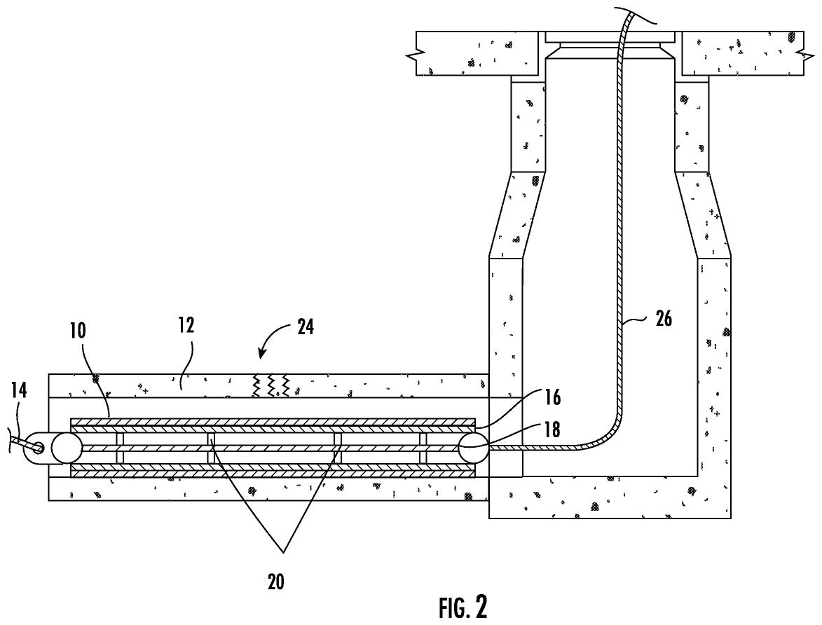

FIG. 2 shows the repair assembly positioned within the pipeline 12 before inflation. The repair assembly includes a liner 10 configured to be impregnated with a resin having one or more light-activated initiators embodied therein. The liner 10 is comprised of a felt layer, which is the lining surface that contacts the interior surface of the host pipe, and a polymer coating is on the opposite surface. The felt layer of the liner 10 is configured to be impregnated with the curable resin having one or more light-activated initiators embodied therein. The one or more light-activated initiators are set to begin curing the resin upon exposure to one or more predetermined wavelengths of light. The one or more wavelengths could be ultra-violate (UV), infrared (IR), violet or blue light (near the end of the visible spectrum), or any other suitable wavelength. The repair assembly also includes a tubular bladder 16 positioned within the liner 10. The tubular bladder 16 is configured to be inflated from a non-inflated first position to an inflated second position. A cross-section of the tubular bladder 16 can be round, oval, or other suitable shapes. The liner 10 may be comprised of what is initially a flat sheet of material wrapped around the outside of the bladder 16. The liner 10 may include overlapping edges to form a tube.

The repair assembly further includes a lighting assembly having a light train 18 positioned within the bladder 16. The lighting assembly is configured to provide light at the same wavelength(s) that trigger(s) the light-activated initiator to begin curing so exposure of the resin to the light from the lighting assembly initiates curing. The bladder 16 is made from a light-permeable material which allows one or more wavelengths of light to pass through to the light-activated initiators impregnated in the liner 10. The bladder 16 material need not be translucent or transparent as long as the wavelength(s) of light which triggers the light-activated initiator is allowed to pass through. In some embodiments the bladder material allows a first wavelength such as UV to pass through but prevents a second wavelength such as visible light from passing through. Selectively allowing only certain wavelengths of light to pass through the bladder 16 helps ensure curing is only initiated at the proper time.

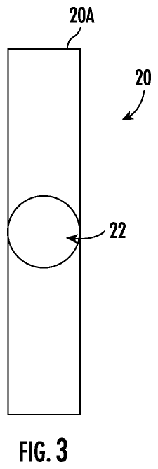

FIG. 3 shows an exemplary light train support, which is a support member 20 in this embodiment. As explained below in more detail, the support members 20 are configured to be secured to the internal surface of the bladder 16 and combined with the light train 18 to help hold the light train 18 near the center of the lumen of the bladder 16 when the bladder 16 is inflated. One or more support members 20, which may be strips of a flexible material such as bladder 16 material, are secured to the internal surface of the bladder 16 at one or more locations along the length of the bladder 16. The support members 20 may include an opening 22 near the middle configured to receive the light train 18 so that the light train 18 is supported near the center of the bladder 16/pipeline 12 lumen when the bladder 16 is in the inflated (second) position. In some embodiments the support members 20 are spaced close enough together along the length of the bladder 16 that the light train 18 does not sag downward between support members 20, or only sags downward slightly between support members 20 so that the light train 18 is maintained as close as possible to the axial center of the lumen of the bladder 16/pipeline 12 when the bladder 16 is inflated.

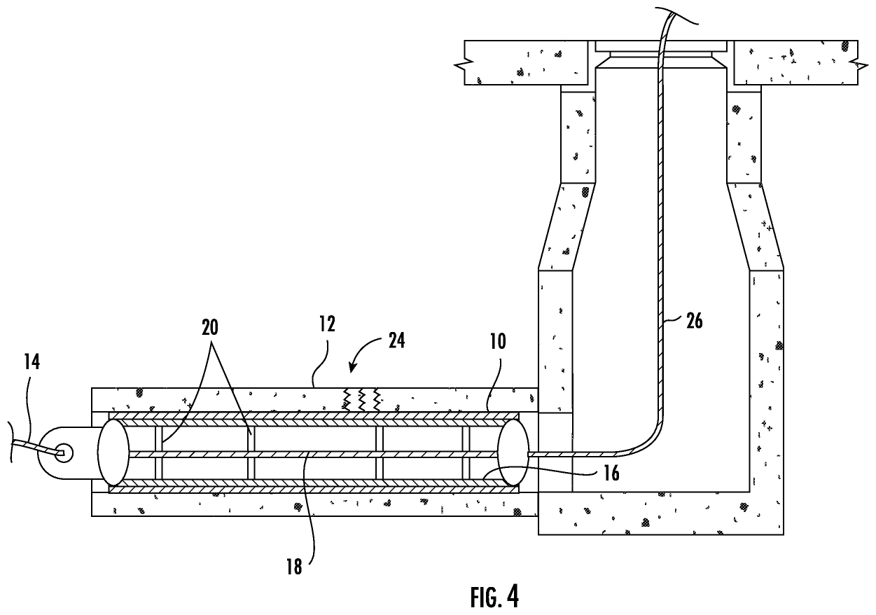

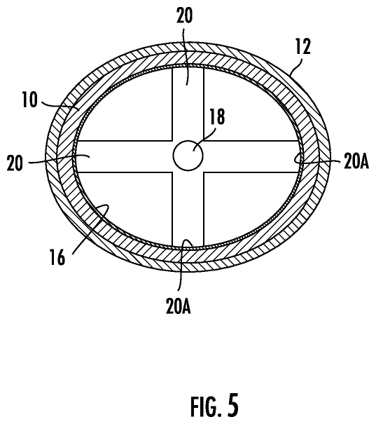

FIGS. 4 and 5 show the repair assembly positioned within the pipeline 12 after the bladder 16 is inflated. Fluid pressure (such as air pressure) is introduced into the bladder 16 through air hose 26, which inflates the bladder 16 and urges the liner 10 into contact with the interior walls of the pipeline 12. The support members 20 have attachment portions 20A, which may be ends, secured to the bladder 16 on generally opposite sides of the internal surface of the bladder 16 so that each support member 20 extends generally across the internal diameter and through the axial center of the bladder 16 when the bladder 16 is inflated (see FIG. 5). In some embodiments, the attachment portions 20A of each support member 20 are staggered at different circumferential positions around the internal surface of the bladder 16. This helps ensure the light train 18 is supported near the center of the lumen regardless of how the liner/bladder assembly is oriented within the pipe 12. In some embodiments, more than one support member 20 is positioned at the same longitudinal position within the bladder 16, but at different circumferential positions so two or more support members 20 intersect near the middle of the inflated bladder 16 at a particular longitudinal position. As shown best in FIG. 5, in some embodiments, the attachment portions 20A of some support members 20 are positioned about ninety degrees from the attachment portions 20A of other support members 20 to create an “X” or cross shape of support members 20. For example, if we assign 0 degrees to an arbitrary circumferential position inside the bladder 16 (such as the bottom), then the opposing attachment portions 20A of a first support member 20 may be attached to the inner circumferential surface of the bladder 16 at 0 degrees and 180 degrees (the top) while the opposing attachment portions 20A of a second support member 20 may be attached to the inner circumferential surface of the bladder 16 at 90 degrees and 270 degrees (opposing sides) causing the two support members 20 to intersect near the center of the lumen of the inflated bladder 16. Again, the multiple support members 20 may be positioned at the same longitudinal position within the bladder 16, but different circumferential positions so multiple support members 20 intersect near the middle of the inflated bladder 16.

The light train 18 is secured to the one or more support members 20 at about the middle of each support member 20 such that when the bladder 16 is inflated, the support members 20 lift the light train 18 upward from where it may be laying before inflation near the bottom of the bladder 16/pipe 12 to support the light train 18 near the axial center of the lumen of the bladder 16/pipe 12. As explained above, each support member 20 may have an opening 22 configured to receive and support the light train 18 such that the light train 18 is effectively threaded through the openings 22 of the successive support members 20 along the length of the bladder 16.

Another aspect of the present invention includes a method of making and using the assembly described above for repairing a pipeline 12 having a damaged portion 24. The method includes making the assembly described above by taking a bladder 16 having a lumen therein, then inverting the bladder 16 (turning the bladder 16 inside out) so the bladder 16 has an inverting face where the outside surface of the bladder 16 becomes the inside surface of the bladder 16. The support members 20 are secured to the inner wall portion of the bladder 16 (within the lumen) of the bladder 16 behind the inverting face. Continuing to invert the bladder 16 and attach support member 20 to the bladder 16 at predetermined longitudinal distances (along the length) of the bladder 16 until a plurality of support member 20 are secured to and spaced within the inside surface of the bladder 16. In some embodiments, the support members 20 are secured to the inner surface of the bladder 16 near (behind) the inverting face. In some embodiments the support member 20 have attachment portions 20A such as ends, and the method includes attaching the opposing attachment portions 20A of the support member 20 to the bladder 16 at locations generally across the internal diameter of the bladder 16 so the support member 20 extend across the lumen and through the axial center of the bladder 16 when the bladder 16 is inflated. In some embodiments, attaching the attachment portions 20A of support members 20 at different circumferential positions around the internal surface of the bladder 16 and at different longitudinal positions so one or more support members 20 are not parallel to each other when viewed longitudinally down the lumen of the inflated bladder 16 (see FIG. 5). In some embodiments, attaching the attachment portions 20A of some support member 20 at about ninety degrees from the attachment portions 20A of other support member 20 to create an “X” or cross shape of support member 20 within the lumen of the bladder 16 (see FIG. 5). In some embodiments, attaching more than one support member 20 to the bladder 16 at the same longitudinal position but at different circumferential portions to create intersecting support members 20. A liner 10 impregnated with resin is then positioned around the bladder 16 and a light train 18 is secured to the support members 20. In some embodiments, the support members have openings 22 near their center and the light train 18 is positioned through the openings 22 of the plurality of support members 20. The assembly may be positioned in the pipeline near the damaged portion 24 by pushing, pulling, or using a positioning device, such as a rope or robot. Fluid pressure (such as air pressure) is introduced to inflate the bladder 16 and urge the liner 10 into contact with the interior walls of the pipeline. Expansion of the bladder 16 causes the support member 20 to extend generally across the axial center of the lumen thereby moving the light train 18 upward to a position near the axial center of the bladder 16 along the length of the assembly. The light train 18 is illuminated to cure the resin. After the liner 10 cures and hardens the bladder 16 tube is deflated and removed with the light train.

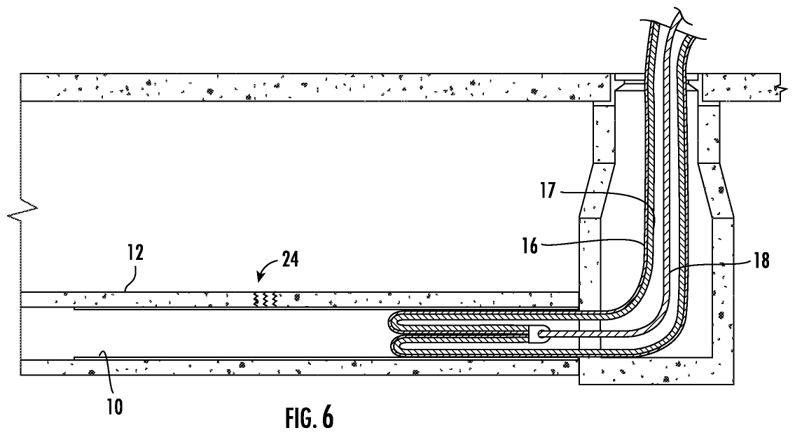

Another embodiment of the invention is shown in FIGS. 6-9 wherein a bladder 16 assembly may be used with a repair assembly for repairing a damaged portion 24 of a pipeline 12. Many components of the repair assembly of this embodiment are similar to those same elements described above, including the liner 10, resin having one or more light-activated initiators embodied therein, bladder 16, and light train 18. The repair assembly is configured to be positioned in the pipeline by any suitable means, including pulling, pushing, or inversion processes.

The repair assembly includes a liner 10 configured to be impregnated with a resin having one or more light-activated initiators embodied therein. The repair assembly also includes a tubular bladder 16 positioned within the liner 10 and a light train support, which is a support layer 17 positioned within the bladder 16 in this embodiment. The bladder 16 and support layer 17 are made from an expandable light-permeable material which allows one or more wavelengths of light to pass through. The support layer 17 may be made of the same material as the bladder 16. The repair assembly further includes a lighting assembly having a light train 18 positioned within the support layer 17. The light train 18 may include an internal conduit configured to convey fluid to inflate the bladder 16 and/or support layer 17.

FIG. 6 shows the assembly being inverted into the pipe 12. In embodiments where the assembly is inverted into the pipe 12, one end of the lateral light train 18 may be directly or indirectly combined with the closed/leading end of the bladder 16 or support layer 17 so that inversion of the bladder 16/support layer 17 pulls the light train 18 into the pipeline 12. As shown in FIG. 6, the bladder 16 and support assembly 17 are being inverted into the liner 10, which was positioned in the pipe 12 first. In other embodiments the liner 10 is inverted into the pipe 12 along with the bladder 16 and support assembly 17 as one single repair assembly. Further, as noted above, the components of the repair assembly may be pulled or pushed into the pipe 12 instead of using inversion, if desired.

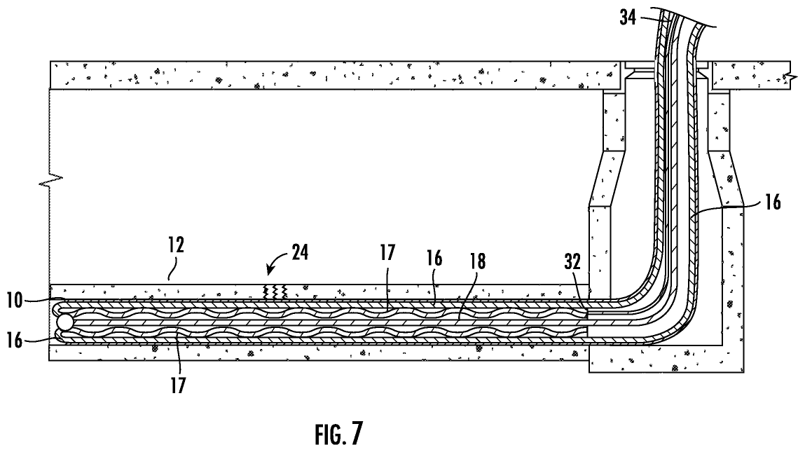

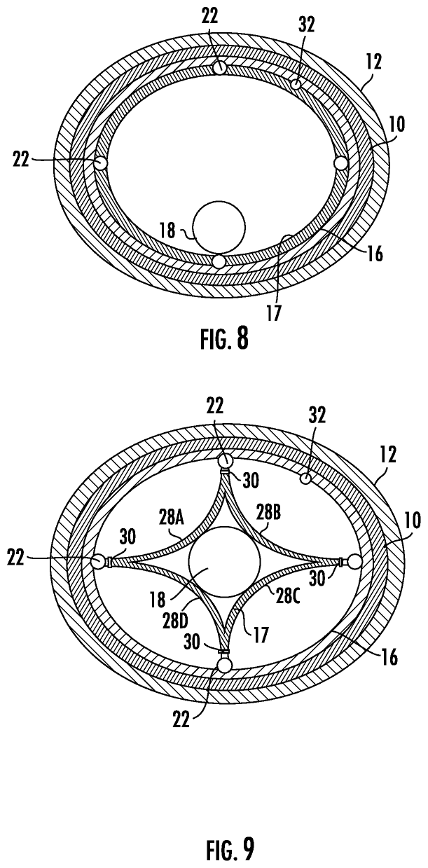

The support layer 17 is fluidly sealed to the bladder 16 at both ends to generally prevent fluid from escaping. In addition, the support layer 17 is secured to the bladder 16 at one or more attachment locations 22 along the length of the support layer 17/bladder 16 assembly. The attachment locations 22 along the length of the assembly may be points periodically spaced along a length of the support layer 17 or longitudinal seams extending along the length of the support layer 17. At each longitudinal attachment location 22, the support layer 17 may be secured to the bladder 16 at multiple circumferential attachment locations 22 (around the internal circumference of the bladder 16/support layer 17). In some embodiments, the support layer 17 is secured to the bladder 16 at four circumferential attachment locations 22 at each longitudinal attachment location 22 as shown in FIGS. 8 and 9, however, more or less circumferential attachment locations 22 may be used. Upon introducing fluid between the bladder 16 and the support layer 17, the support layer 17 inflates inwardly to create support cushions 28A, 28B, 28C, 28D between each of the circumferential attachment locations 22, as shown in FIGS. 7 and 9. The support cushions 28A, 28B, 28C, 28D effectively narrow the lumen of the support layer 17 as they are inflated causing the light train 18 to be raised toward the axial center of the assembly.

If the attachment location 22 is a seam extending generally along the length of the support layer 17, then the area between each seam 22 (each support cushion 28) is fluidly isolated from the other support cushions 28A, 28B, 28C, 28D. In order to allow fluid to flow between each seam 22 and inflate all of the support cushions 28 from a single fluid inlet, this embodiment may include openings or conduits 30 between each support layer 17 as shown in FIG. 9.

In use, the assembly is created by positioning a support layer 17 inside the bladder 16 and securing the support layer 17 to the inside of the bladder 16 at a plurality of attachment location 22, which may be points or seams. In some embodiments the support layer 17 is combined with the bladder 16 along multiple longitudinal attachment axis spaced about 90 degrees from each other. This creates four inwardly expanding cushion portions 28A, 28B, 28C, 28D of the support layer 17 between the four attachment location 22 axis. The repair assembly is positioned in the pipe 12 by any suitable means, including pushing, pulling, or inversion. The liner 10, bladder 16, and support layer 17 may be positioned at the same time, or the liner 10 may be positioned first, followed by the bladder 16 and support layer 17. In inversion embodiments, one end of the lateral light train 18 is directly or indirectly combined with the closed/leading end of the bladder 16 or support layer 17 so that inversion of the bladder 16/support layer 17 pulls the light train 18 into the pipeline. The bladder 16 and support layer 17 are inflated using fluid pressure after being positioned in the pipe to expand outward and urge the liner 10 into contact with the inner wall of the pipe 12. Fluid pressure is then introduced into an opening 32 or valve configured to allow fluid to be directed from an air hose 34 between the bladder 16 and the support layer 17 causing the inflated bladder 16 to remain in place against the liner 10 and the support layer 17 to expand inwardly like one or more cushions 28A, 28B, 28C, 28D toward the center of the lumen. In some embodiments the conduit conveying the fluid introduced to inflate the bladder 16 and support layer 17 in the first inflation step is the same as the conduit conveying the fluid introduced to inflate the support layer 17 inward in the second inflation step. As shown in FIG. 7, in other embodiments two separate conduits 18, 34 are used (where light train 18 includes an internal fluid conduit). The inwardly expanding support layer 17 lifts the light train 18 upward from the lower portion of the pipe 12 and supports the light train 18 near the center of the lumen. The light train 18 is illuminated to cure the resin. After the liner 10 cures and hardens the bladder 16 and support layer 17 are deflated and removed with the light train 18.

Having thus described the invention in connection with the preferred embodiments thereof, it will be evident to those skilled in the art that various revisions can be made to the preferred embodiments described herein without departing from the spirit and scope of the invention. It is my intention, however, that all such revisions and modifications that are evident to those skilled in the art will be included with in the scope of the following claims.

What is claimed is as follows:

1. A bladder assembly for use with a repair assembly for repairing a pipeline, the bladder assembly comprising:
a tubular bladder having a length, an internal surface, and an internal circumference, the tubular bladder configured to be inflated from a non-inflated position to an inflated position wherein a lumen extends along the length; and
one or more light train supports positioned within the tubular bladder.

2. The bladder assembly of claim 1 wherein the one or more light train supports are attached to the bladder and configured to move a light train toward a center of the lumen when the bladder is being inflated from the non-inflated position to the inflated position.

3. The bladder assembly of claim 1 wherein the one or more light train supports are secured to the internal surface of the tubular bladder.

4. The bladder assembly of claim 1 wherein the one or more light train supports are support members secured to the tubular bladder at predetermined positions along the length of the tubular bladder and at predetermined positions around the internal circumference of the tubular bladder.

5. The bladder assembly of claim 4 wherein the tubular bladder has a first portion on a first side of the internal circumference and a second portion on a second side of the internal circumference that is generally opposite the first side, and a first one of the support members has a first end attached to the first portion and a second end attached to the second portion such that the first one of the support members extends generally across the lumen when the tubular bladder is in the inflated position.

6. The bladder assembly of claim 5 wherein the tubular bladder has a third portion on a third side of the internal circumference and a fourth portion on a fourth side of the internal circumference that is generally opposite the third side, and a second one of the support members has a first end attached to the third portion and a second end attached to the fourth portion such that the second one of the support members extends generally across the lumen when the tubular bladder is in the inflated position.

7. The bladder assembly of claim 6 wherein the first end of the first one of the support members is positioned about ninety degrees from the first end of the second one of the support members.

8. The bladder assembly of claim 4 wherein the support members have openings configured to receive the light train.

9. The bladder assembly of claim 4 wherein the support members are strips having ends secured to the internal surface of the bladder and openings configured to receive the light train.

10. The bladder assembly of claim 4 wherein a first one of the support members is secured to the bladder at a first longitudinal position along the length of the bladder and a second one of the support members is secured to the tubular bladder at a second longitudinal position along the length of the tubular bladder.

11. The bladder assembly of claim 4 wherein a first one of the support members is secured to the tubular bladder at a first circumferential position within the bladder and a second one of the support members is secured to the tubular bladder at a second circumferential position within the bladder.

12. The bladder assembly of claim 11 wherein the first circumferential position is about ninety degrees from the second circumferential position.

13. The bladder assembly of claim 4 wherein a first one of the support members is secured to the tubular bladder at a first longitudinal position along the length of the tubular bladder and a first circumferential position within the tubular bladder and a second one of the support members is secured to the bladder at the first longitudinal position along the length of the tubular bladder and a second circumferential position within the tubular bladder.

14. The bladder assembly of claim 1 wherein the one or more light train supports is a support layer.

15. The bladder assembly of claim 14 wherein the support layer is secured to the internal surface of the bladder at one or more attachment locations, the support layer having one or more inflatable support cushions adjacent to the attachment locations.

16. The bladder assembly of claim 15 further comprising openings through which the one or more inflatable support cushions are in fluid communication with each other.

17. The bladder assembly of claim 15 wherein the one or more inflatable support cushions are configured to be inflated from a non-inflated position to an inflated position wherein the support cushions are configured to support the light train.

18. The bladder of claim 15 wherein the attachment locations are seams extending along the length of the bladder.

19. The bladder of claim 15 wherein the support layer is attached to the internal surface of the bladder at a first attachment location, a second attachment location, a third attachment location, and a fourth attachment location, the attachment locations creating a first support cushion between the first and second attachment locations, a second support cushion between the second and third attachment locations, a third support cushion between the third and fourth attachment locations, and a fourth support cushion between the fourth and the first attachment locations.

20. The bladder of claim 14 further comprising an opening configured to allow fluid to be directed between the bladder and the support layer causing the support layer to expand inwardly toward the center of the lumen after the bladder has expanded outwardly toward the pipeline.

21. A repair assembly for repairing a pipeline, the repair assembly comprising:
a liner configured to be impregnated with a resin having one or more light-activated initiators embodied therein;
a tubular bladder having a length, an internal surface, and an internal circumference, the tubular bladder configured to be inflated from a non-inflated position to an inflated position wherein a lumen extends along the length;
one or more light train supports secured to the tubular bladder at predetermined positions along the length of the tubular bladder and at predetermined positions around the internal circumference of the tubular bladder; and
a lighting assembly having a light train positioned within the one or more light train supports, wherein the light train supports are configured to move the light train toward the center of the lumen when the bladder is inflated from the non-inflated position to the inflated position.

22. The repair assembly of claim 21 wherein the one or more light train supports are support members.

23. The bladder assembly of claim 22 wherein the support members are strips having ends secured to the internal surface of the bladder and openings configured to receive the light train.

24. The bladder assembly of claim 22 wherein a first one of the support members is secured to the bladder at a first longitudinal position along the length of the bladder and a second one of the support members is secured to the tubular bladder at a second longitudinal position along the length of the tubular bladder.

25. The bladder assembly of claim 22 wherein a first one of the support members is secured to the tubular bladder at a first circumferential position within the bladder and a second one of the support members is secured to the tubular bladder at a second circumferential position within the bladder.

26. The repair assembly of claim 21 wherein the one or more light train supports is a support layer.

27. The bladder assembly of claim 26 wherein the support layer is secured to the internal surface of the bladder at one or more attachment locations, the support layer having one or more inflatable support cushions adjacent to the attachment locations.

28. The bladder assembly of claim 26 further comprising openings through which the one or more inflatable support cushions are in fluid communication with each other.

29. The bladder assembly of claim 26 wherein the one or more inflatable support cushions are configured to be inflated from a non-inflated position to an inflated position wherein the support cushions are configured to support the light train.

30. The bladder of claim 26 wherein the attachment locations are seams extending along the length of the bladder.

31. The bladder of claim 26 further comprising an opening configured to allow fluid to be directed between the bladder and the support layer causing the support layer to expand inwardly toward the center of the lumen after the bladder has expanded outwardly toward the pipeline.

32. A method of repairing a pipeline, said method comprising:
taking a repair assembly having a resin impregnable liner, an inflatable bladder having a lumen and one or more light train supports positioned therein, and a lighting assembly having a light train positioned within the inflatable bladder;
positioning the liner at least partially around the bladder;
impregnating the liner with a resin capable of curing and hardening;
positioning the repair assembly in the pipeline;
inflating the bladder using fluid pressure causing the repair assembly to expand outwardly toward the inside wall of the pipeline and the light train supports to move the light train toward a center of the lumen; and
removing the bladder from the pipeline after the liner has cured and hardened.

33. The method of claim 32 wherein the one or more light train supports are one or more support members.

34. The method of claim 33 wherein the support members have openings and the method further comprises threading the light train through the openings in the support members.

35. The method of claim 32 wherein the one or more light train supports is a support layer.

36. The method of claim 35 wherein the liner is positioned in the pipeline by inversion.

37. The method of claim 35 wherein the method further comprises inflating the support layer to create one or more support cushions inside the bladder.

38. The method of claim 35 further comprising expanding the support layer inwardly toward the center of the lumen after the repair assembly has been expanded outwardly toward the inside wall of the pipeline.
